(19) United States
(12) Patent Application Publication
(10) Pub. No.: US 2023/0060452 A1
(43) Pub. Date: Mar. 2, 2023

(54) System and Method for Adjusting a Model

(71) Applicant: Visa International Service Association, (US)

(72) Inventors: Nuri Vinod Purswani Ramchandani, Singapore (SG); Ajit Vilasrao Patil, Cumming, GA (US); Shuang Xia, Pleasanton, CA (US); Shrey Nautiyal, Foster City, CA (US); Neil O. Rubens, Saitama (JP); Amir Shareghi Najar, Harrington Park (AU); Hasan Al-Madfai, London (GB); Suresh Krishna Vaidyanathan, Dublin, CA (US)

(21) Appl. No.: 17/893,348

(22) Filed: Aug. 23, 2022

Related U.S. Application Data
(60) Provisional application No. 63/236,289, filed on Aug. 24, 2021.

(51) Int. Cl. G06Q 30/02; G06N 5/02

(52) U.S. Cl. CPC G06Q 30/0204; G06N 5/022

(57) ABSTRACT

Provided is a system, method, and computer program product for adjusting a model. The method includes training or receiving a model based on transaction data for a plurality of account holders, the model configured to classify each individual of the plurality of account holders, segmenting each individual of at least a portion of account holders of the plurality of account holders into at least one subgroup of a plurality of subgroups, separately executing the model for each subgroup of the plurality of subgroups by inputting, into the model, a portion of the transaction data associated with individuals in each subgroup, comparing a plurality of outputs of the model resulting from the separate execution of the model for each subgroup of the plurality of subgroups, and adjusting the model based on at least one differential between the plurality of outputs.

### CROSS-REFERENCE TO RELATED APPLICATION

This application claims priority to U.S. Provisional Patent Application No. 63/236,289, filed Aug. 24, 2021, the disclosure of which is hereby incorporated by reference in its entirety.

### BACKGROUND

### 1. Technical Field

This disclosure relates generally to adjusting a model and, in non-limiting embodiments, systems, methods, and computer program products for adjusting a classification model and/or propensity model to correct bias.

### 2. Technical Considerations

Models, such as classification and propensity models, are often used for targeted offers and personalization of products/services. Such models may have unintended consequences such as discrimination in who receives offers, overwhelming customers with offers, sending unethical offers to vulnerable demographic groups (e.g., alcohol promotion in teenage groups), and/or the like.

### SUMMARY

According to non-limiting embodiments or aspects, provided is a computer-implemented method comprising: training or receiving, with at least one processor, a model based on transaction data for a plurality of account holders, the model configured to classify each individual of the plurality of account holders; segmenting, with at least one processor, each individual of at least a portion of account holders of the plurality of account holders into at least one subgroup of a plurality of subgroups; separately executing, with at least one processor, the model for each subgroup of the plurality of subgroups by inputting, into the model, a portion of the transaction data associated with individuals in each subgroup; comparing, with at least one processor, a plurality of outputs of the model resulting from the separate execution of the model for each subgroup of the plurality of subgroups; and adjust, with at least one processor, the model based on at least one differential between the plurality of outputs.

In non-limiting embodiments or aspects, segmenting each individual of the plurality of account holders into the at least one subgroup of the plurality of subgroups comprises: determining, with at least one processor, that at least one account holder parameter for the individual matches a predetermined account holder parameter comprising at least one of the following: a gender, an age, an age range, a location, a region, a credit limit, an account balance, or any combination thereof; and in response to determining that the at least one account holder parameter matches the predetermined account holder parameter, associating an identifier corresponding to each individual to a subgroup corresponding to the predetermined account holder parameter. In non-limiting embodiments or aspects, comparing the plurality of outputs of the model from the separate execution of the model for each subgroup of the plurality of subgroups comprises: determining, for each subgroup of the plurality of subgroups, a metric based on at least one output associated with the subgroup; and determining the at least one differential based on a difference between the metric for a first subgroup of the plurality of subgroups and at least one of the following: a metric for a second subgroup of the plurality of subgroups, an average metric for the plurality of subgroups, a median metric for the plurality of subgroups, or any combination thereof. In non-limiting embodiments or aspects, comparing the plurality of outputs of the model from the separate execution of the model for each subgroup of the plurality of subgroups comprises: determining, with at least one processor, that a predetermined number of account holder parameters for each individual are the basis for at least a predetermined percentage of an output of the plurality of outputs. In non-limiting embodiments or aspects, the method further comprises generating, with at least one processor, the model. In non-limiting embodiments or aspects, the method further comprises receiving, from a remote computing device, the model; and communicating the model to the remote computing device after it is adjusted.

According to non-limiting embodiments or aspects, provided is a system comprising at least one processor configured to: train a model based on transaction data for a plurality of account holders, the model configured to classify each individual of the plurality of account holders; segment each individual of at least a portion of account holders of the plurality of account holders into at least one subgroup of a plurality of subgroups; separately execute the model for each subgroup of the plurality of subgroups by inputting, into the model, a portion of the transaction data associated with individuals in each subgroup; compare a plurality of outputs of the model resulting from the separate execution of the model for each subgroup of the plurality of subgroups; and adjust the model based on at least one differential between the plurality of outputs.

In non-limiting embodiments or aspects, segmenting each individual of the plurality of account holders into the at least one subgroup of the plurality of subgroups comprises: determining that at least one account holder parameter for each matches a predetermined account holder parameter comprising at least one of the following: a gender, an age, an age range, a location, a region, a credit limit, an account balance, or any combination thereof; and in response to determining that the at least one account holder parameter matches the predetermined account holder parameter, associating an identifier corresponding to the individual to a subgroup corresponding to the predetermined account holder parameter. In non-limiting embodiments or aspects, comparing the plurality of outputs of the model from the separate execution of the model for each subgroup of the plurality of subgroups comprises: determining, for each subgroup of the plurality of subgroups, a metric based on at least one output associated with the subgroup; and determining the at least one differential based on a difference between the metric for a first subgroup of the plurality of subgroups and at least one of the following: a metric for a second subgroup of the plurality of subgroups, an average metric for the plurality of subgroups, a median metric for the plurality of subgroups, or any combination thereof. In non-limiting embodiments or aspects, comparing the plurality of outputs of the model from the separate execution of the model for each subgroup of the plurality of subgroups comprises determining that a predetermined number of account holder parameters for each individual are the basis for at least a predetermined percentage of an output of the plurality of outputs. In non-limiting embodiments or aspects, the at least one processor is further configured to generate the model. In non-limiting embodiments or aspects, the at least one processor is further configured to: receive, from a remote computing device, the model; and communicate the model to the remote computing device after it is adjusted.

According to non-limiting embodiments or aspects, provided is a computer program product comprising at least one non-transitory medium including program instructions which, when executed by at least one processor, cause the at least one processor to: train a model based on transaction data for a plurality of account holders, the model configured to classify each individual of the plurality of account holders; segment each individual of at least a portion of account holders of the plurality of account holders into at least one subgroup of a plurality of subgroups; separately execute the model for each subgroup of the plurality of subgroups by inputting, into the model, a portion of the transaction data associated with individuals in each subgroup; compare a plurality of outputs of the model resulting from the separate execution of the model for each subgroup of the plurality of subgroups; and adjust the model based on at least one differential between the plurality of outputs.

Other non-limiting embodiments or aspects will be set forth in the following numbered clauses:

Clause 1: A computer-implemented method comprising: training or receiving, with at least one processor, a model based on transaction data for a plurality of account holders, the model configured to classify each individual of the plurality of account holders; segmenting, with at least one processor, each individual of at least a portion of account holders of the plurality of account holders into at least one subgroup of a plurality of subgroups; separately executing, with at least one processor, the model for each subgroup of the plurality of subgroups by inputting, into the model, a portion of the transaction data associated with individuals in each subgroup; comparing, with at least one processor, a plurality of outputs of the model resulting from the separate execution of the model for each subgroup of the plurality of subgroups; and adjust, with at least one processor, the model based on at least one differential between the plurality of outputs.

Clause 2: The computer-implemented method of clause 1, wherein segmenting each individual of the plurality of account holders into the at least one subgroup of the plurality of subgroups comprises: determining, with at least one processor, that at least one account holder parameter for the individual matches a predetermined account holder parameter comprising at least one of the following: a gender, an age, an age range, a location, a region, a credit limit, an account balance, or any combination thereof; and in response to determining that the at least one account holder parameter matches the predetermined account holder parameter, associating an identifier corresponding to each individual to a subgroup corresponding to the predetermined account holder parameter.

Clause 3: The computer-implemented method of clauses 1 or 2, wherein comparing the plurality of outputs of the model from the separate execution of the model for each subgroup of the plurality of subgroups comprises: determining, for each subgroup of the plurality of subgroups, a metric based on at least one output associated with the subgroup; and determining the at least one differential based on a difference between the metric for a first subgroup of the plurality of subgroups and at least one of the following: a metric for a second subgroup of the plurality of subgroups, an average metric for the plurality of subgroups, a median metric for the plurality of subgroups, or any combination thereof.

Clause 4: The computer-implemented method of any of clauses 1-3, wherein comparing the plurality of outputs of the model from the separate execution of the model for each subgroup of the plurality of subgroups comprises: determining, with at least one processor, that a predetermined number of account holder parameters for each individual are the basis for at least a predetermined percentage of an output of the plurality of outputs.

Clause 5: The computer-implemented method of any of clauses 1-4, further comprising: generating, with at least one processor, the model.

Clause 6: The computer-implemented method of any of clauses 1-5, further comprising: receiving, from a remote computing device, the model; and communicating the model to the remote computing device after it is adjusted.

Clause 7: A system comprising at least one processor configured to: train a model based on transaction data for a plurality of account holders, the model configured to classify each individual of the plurality of account holders; segment each individual of at least a portion of account holders of the plurality of account holders into at least one subgroup of a plurality of subgroups; separately execute the model for each subgroup of the plurality of subgroups by inputting, into the model, a portion of the transaction data associated with individuals in each subgroup; compare a plurality of outputs of the model resulting from the separate execution of the model for each subgroup of the plurality of subgroups; and adjust the model based on at least one differential between the plurality of outputs.

Clause 8: The system of clause 7, wherein segmenting each individual of the plurality of account holders into the at least one subgroup of the plurality of subgroups comprises: determining that at least one account holder parameter for each matches a predetermined account holder parameter comprising at least one of the following: a gender, an age, an age range, a location, a region, a credit limit, an account balance, or any combination thereof; and in response to determining that the at least one account holder parameter matches the predetermined account holder parameter, associating an identifier corresponding to the individual to a subgroup corresponding to the predetermined account holder parameter.

Clause 9: The system of clauses 7 or 8, wherein comparing the plurality of outputs of the model from the separate execution of the model for each subgroup of the plurality of subgroups comprises: determining, for each subgroup of the plurality of subgroups, a metric based on at least one output associated with the subgroup; and determining the at least one differential based on a difference between the metric for a first subgroup of the plurality of subgroups and at least one of the following: a metric for a second subgroup of the plurality of subgroups, an average metric for the plurality of subgroups, a median metric for the plurality of subgroups, or any combination thereof.

Clause 10: The system of any of clauses 7-9, wherein comparing the plurality of outputs of the model from the separate execution of the model for each subgroup of the plurality of subgroups comprises: determining that a predetermined number of account holder parameters for each individual are the basis for at least a predetermined percentage of an output of the plurality of outputs.

Clause 11: The system of any of clauses 7-10, wherein the at least one processor is further configured to generate the model.

Clause 12: The system of any of clauses 7-11, wherein the at least one processor is further configured to: receive, from a remote computing device, the model; and communicate the model to the remote computing device after it is adjusted.

Clause 13: A computer program product comprising at least one non-transitory medium including program instructions which, when executed by at least one processor, cause the at least one processor to: train a model based on transaction data for a plurality of account holders, the model configured to classify each individual of the plurality of account holders; segment each individual of at least a portion of account holders of the plurality of account holders into at least one subgroup of a plurality of subgroups; separately execute the model for each subgroup of the plurality of subgroups by inputting, into the model, a portion of the transaction data associated with individuals in each subgroup; compare a plurality of outputs of the model resulting from the separate execution of the model for each subgroup of the plurality of subgroups; and adjust the model based on at least one differential between the plurality of outputs.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for adjusting a model according to non-limiting embodiments or aspects;

FIG. 2 illustrates example components of a device used in connection with non-limiting embodiments or aspects;

FIG. 3 is a flow diagram of a method for adjusting a model according to non-limiting embodiments or aspects;

FIG. 4 is another schematic diagram of a system for adjusting a model according to non-limiting embodiments or aspects;

FIG. 5 is a graphical user interface or component thereof according to non-limiting embodiments;

FIG. 6 is a graphical user interface or component thereof according to non-limiting embodiments; and

FIG. 7 is a graphical user interface or component thereof according to non-limiting embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

In non-limiting embodiments, a system, method, and computer program product for adjusting a model provides for the analysis and adjustment of a model, such as a machine-learning model, based on one or more parameters. Non-limiting embodiments may be used to determine a neutrality and/or bias of a model, such as whether the model is exclusive or inclusive, and to what degree. As an example, a model for providing offers (e.g., discounts, coupons, recommendations, loyalty programs, and/or the like) may exclude one or more users based on one or more attributes of the user, despite the offer being available and/or applicable to the user. Other biases in models may be identified in non-limiting embodiments. Through arrangements described herein, non-limiting embodiments provide for the adjustment of a model based on a bias determination to at least partially improve the model (e.g., reduce bias and/or increase neutrality).

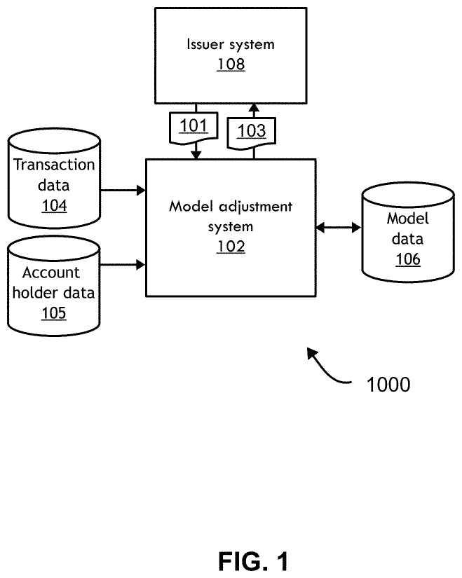

FIG. 1 depicts a system 1000 for adjusting a model according to non-limiting embodiments or aspects. The system 1000 includes a model adjustment system 102, which may include one or more computing devices executing one or more software applications. The model adjustment system 102 may be part of or in communication with a transaction processing system of a transaction service provider, although it will be appreciated that it may also be a separate system and/or part of another system. The model adjustment system 102 is in communication with a transaction database 104 including transaction data for a plurality of transactions conducted between a plurality of account holders (e.g., customers) and a plurality of merchants.

In non-limiting embodiments, the transaction database 104 may also include account holder data for each of a plurality of account holders. In some examples, the account holder data may be part of the transaction records in the transaction database 104, such as one or more account holder parameters associated with an account holder. An account holder parameter may include, as an example, a birthdate, age, gender, geographic location (e.g., coordinates, an address, and/or the like), region (e.g., a town, a city, a state, a country, a boundary, and/or the like), account usage (e.g., frequency of usage), account credit limit, account balance, and/or the like. In some non-limiting embodiments, the account holder data may be stored in a separate database and/or a separate system (e.g., issuer system 108) and retrieved by the model adjustment system 102. In some embodiments or aspects, the account holder data may also include user preference information (e.g., vehicle preference) and/or demographic information.

Still referring to FIG. 1, the model adjustment system 102 may receive, as an input, a model 101 for analysis. The model 101 may be received and/or obtained from a model database 106. Additionally or alternatively, the model 101 may be provided by an issuer system 108. For example, an issuer system 108 corresponding to an issuer institution that issued an account to the account holder may be in communication with the model adjustment system 102 via an electronic payment processing network. In some non-limiting embodiments, the model adjustment system 102 may be in communication with several different issuer systems (not shown in FIG. 1). In some non-limiting embodiments, the model adjustment system 102 may be part of an issuer system 108.

In non-limiting embodiments, the model 101 may be configured to classify individual account holders for various different types of classification and/or to determine a propensity that an individual account holder will take an action. For example, the model 101 may include a machine-learning model configured to classify an account holder for eligibility for a promotion or offer, for eligibility for a particular product, for automatic provision of a promotion or offer, and/or the like. The model 101 may use, as input, one or more account holder parameters. In some examples, the model 101 may be used by an issuer system 108 to determine rewards points, rewards eligibility, account status, credit limit, and/or the like. The model 101 may also be used by one or more merchants (not shown in FIG. 1) to provide offers and/or other services to account holders (e.g., customers). The model 101 and/or model adjustment system 102 may be used by participants in an electronic payment processing system, such as issuers, acquirers, merchants, payment gateways, transaction processing systems, and/or the like.

In non-limiting embodiments, the model adjustment system 102 or a separate training system may train the model 101 based on the transaction database 104 for the plurality of account holders. Various forms of training techniques may be used. In some examples, the model adjustment system 102 may receive a model 101 that has already been trained. Once in receipt of a trained model 101, the model adjustment system 102 may execute the model 101 for each individual account holder of the plurality of account holders to result in an output for each account holder.

In non-limiting embodiments, the model adjustment system 102 may segment the plurality of account holders into a plurality of different subgroups based on one or more account holder parameters and/or based on other criteria. For example, the segmentation may be based on account holder data stored in an account holder database 105. As an example, even if the transaction records from the transaction database 104 do not specify an age of the account holder, the age and/or age range of the account holder may be known in the account holder database 105 and used as the basis to segment the account holders into different age groups. As another example, the location and/or region of the account holders may be determined from an address, zip code, and/or the like, and used as the basis to segment the account holders into different locations and/or regions. In some non-limiting embodiments, the account holder data and/or a portion thereof may be provided by the issuer system 108 or another system requesting analysis of a model. Additionally or alternatively, the segmentation may be based on account holder parameters that are directly stored in the transaction database 104 as part of transaction records and/or provided by an external system or entity.

With continued reference to FIG. 1, after segmenting the account holders into a plurality of subgroups, the model adjustment system 102 may determine the outputs for each individual in each subgroup, from the previous execution of the model, and/or from separately executing the model 101 for each individual in each subgroup. For example, each account holder in a particular subgroup may be processed with the model 101 and the outputs for that subgroup may be combined (e.g., merged, averaged, associated, and/or the like). Each subgroup may be similarly processed. The model adjustment system 102 may compare the plurality of outputs of the model 101 resulting from the separate execution of the model 101 for each subgroup of the plurality of subgroups. In some non-limiting examples, a comparison metric (e.g., a value or set of values that can be used for comparison) is determined for each subgroup by, for example, the combined outputs for that subgroup. For example, a comparison metric may be a single value, a vector, a set of values, and/or the like. A comparison metric may be determined for each of the plurality of account holders. In non-limiting embodiments, a comparison metric may be based on all of the model outputs or a subgroup of all of the model outputs corresponding to a subgroup. A differential (e.g., a numerical difference, a spatial difference in a vector representation, and/or the like) may be determined between the comparison metrics. For example, a differential may represent the difference between two or more comparison metrics.

In non-limiting embodiments, based on one or more differentials associated with one or more subgroups, a bias may be identified by determining that one or more subgroups are associated with a differential (e.g., based on a comparison to another subgroup, an average subgroup, average values from all subgroups, and/or the like) that satisfies a threshold (e.g., meets or exceeds a threshold). For example, such a bias can be identified by determining that a predetermined number of parameters (e.g., five) is the basis for (e.g., account for) at least a predetermined percentage (e.g., 50%) of the influence in the model 101. Other variations and threshold values are possible. In some non-limiting examples, a correlation may be determined between a first account holder parameter (e.g., vehicle preference) for a particular subgroup and one or more other account holder parameters such as gender, age, ethnicity, and/or the like such that a bias can be determined based on the first account holder parameter (e.g., vehicle preference) that affects a bias in the one or more other account holder parameters.

After a bias has been determined, the model adjustment system 102 adjusts the model 101 based on the differential to at least partially correct the bias. As an example, the model 101 may be automatically adjusted based on a target output value, which may be determined from the outputs from other subgroups and/or the plurality of account holders. Adjusting the model 101 may include, for example, decreasing and/or increasing the impact of one or more parameters considered by the model 101. Such a process may involve first determining one or more parameters that are causing a bias in one or more subgroups. In non-limiting embodiments, the model 101 may be automatically adjusted in response to determining a bias (e.g., an associated differential or other metric associated with the bias) that satisfies a threshold.

In non-limiting embodiments or aspects, the model adjustment system 102 may adjust the model 101 by removing and/or reducing the weight of one or more variables that correspond to account holder parameters determined to be causing the bias (e.g., accounting for at least a predetermined percentage of influence on the model). An adjusted model 103 may then be executed based on the same input data (e.g., the same account holder parameters for a particular subgroup). The model 101 may be adjusted by removing, adding, rebalancing, and/or combining input variables. In some examples, a target bias is identified such that, even if the bias cannot be entirely eliminated, the model 101 is approved if the bias (e.g., differential) is equal to or less than a target threshold. Once adjusted, the model adjustment system 102 outputs the adjusted model 103 to the model database 106 and/or the issuer system 108 or some other external system.

In non-limiting embodiments, the model 101 may be part of an autonomous system that self-adjusts to achieve desired results and/or optimization. The model 101 may be automatically adjusted continuously and/or periodically.

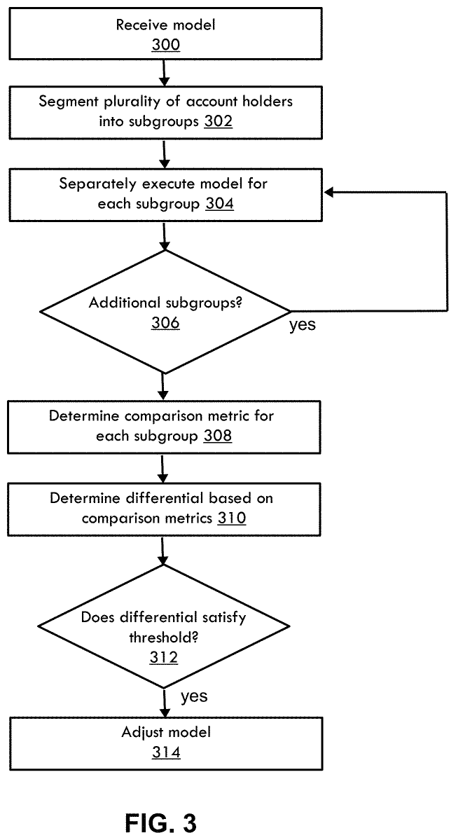

Referring to FIG. 3, a flow diagram is shown for a method of adjusting a model according to non-limiting embodiments. It will be appreciated that the steps shown in FIG. 3 are for example purposes only, and that additional, fewer, different, and/or a different order of steps may be used in non-limiting embodiments. At first step 300, a model is received. The model may be received from an issuer system, as an example, by a server computer through one or more Application Programming Interfaces (APIs) or the like. In some examples, the model may already be stored on the computing device (e.g., the server computing device, local computing device, or the like) such that receiving the model includes identifying the location of the model. The model may be configured to classify an account holder based on transaction data. For example, the model may have been trained and/or programmed to classify account holders for a propensity to engage in an offer (e.g., use a provided discount, make a particular type of purchase, and/or the like). It will be appreciated that the model may be configured to classify account holders based on any of one or more parameters, such as transaction data, account holder data (e.g., demographic data, account history, and/or the like), and/or other information available about each account holder and/or an associated account.

At step 302, each account holder of a plurality of account holders may be segmented into one or more subgroups. For example, segmenting each account holder may include determining that at least one account holder parameter for the individual matches a predetermined account holder parameter. The account holder parameters may include, for example, a gender, an age, an age range, a location, a region, an ethnicity, a credit limit, an account balance, and/or the like. In response to determining that one or more account holder parameters matches the predetermined account holder parameter, an identifier corresponding to a subgroup may be associated with the account and/or account holder. For example, each subgroup and/or individual account holder in each subgroup may be labeled with a classification identifying the subgroup.

At step 304, the model may be executed for each subgroup of the plurality of subgroups by inputting parameters (e.g., such as a portion of the transaction data associated with individual account holders in each subgroup) into the model. Executing the model may be performed for each account holder and/or for aggregated values representing all account holders in a subgroup (e.g., average or median values). For example, executing the model for each subgroup may include executing the model for each account holder in each subgroup based on transaction data for that account holder. In some examples, the output of the model for each account holder may be combined (e.g., averaged, summed, and/or the like) with the other outputs within that subgroup. In other non-limiting examples, executing the model for each subgroup may include executing the model using input values that are based on a combination of values of each account holder of the subgroup (e.g., averaged transaction data).

At step 306 it is determined if there are additional subgroups to process and the method may loop between steps 304 and 306 until the model has been executed for each subgroup and/or each account holder in each subgroup. Once the model has been executed for all of the subgroups, at step 308 a comparison metric is determined for each subgroup. For example, a comparison metric may be determined by combining (e.g., averaging, summing, and/or the like) the model output values of each individual account holder in the subgroup. Additionally or alternatively, a comparison metric may be determined for each of the plurality of account holders and combined into a comparison metric for a subgroup.

At step 310, the comparison metric for a subgroup is compared to one or more other subgroups to determine a differential. In some examples, each comparison metric may be compared to each other comparison metric, resulting in a plurality of differentials. In some examples, the comparison metrics are combined (e.g., averaged) and the combined comparison metric is compared to each individual comparison metric to determine a differential. In some examples, a highest valued comparison metric is compared to each other comparison metric. In some examples, a median value comparison metric is compared to each other comparison metric. In non-limiting embodiments, a differential is determined between the metric for a first subgroup of the plurality of subgroups and at least one of the following: a metric for a second subgroup of the plurality of subgroups, an average metric for the plurality of subgroups, and/or a median metric for the plurality of subgroups. A differential may be determined for a second subgroup, third subgroup, and the like.

At step 312, a determination is made whether one or more differentials determined at step 310 satisfies (e.g., meets or exceeds) a threshold. In some examples, determining whether a differential satisfies a threshold may include determining that a predetermined number of account holder parameters for each individual is the basis for at least a predetermined percentage of an output of the plurality of outputs (e.g., a threshold basis). For example, it may be determined that a predetermined number of parameters (e.g., five) is the basis for (e.g., account for) at least a predetermined percentage (e.g., 50%) of the influence in the model. Different values may be used for the predetermined number of parameters (e.g., one or more) and/or the predetermined percentage of influence. In some non-limiting embodiments, a differential may represent a difference in parameter values that influence an outcome of the model.

At step 314, the model is adjusted based on the differential determined at step 312. For example, the model may be adjusted based on a target output value for a given set of inputs (e.g., inputs for a subgroup). A subgroup determined to be subject to model bias due to an influence of one or more parameters on the output may be associated with a target output based on outputs from other subgroups and/or account holders processed by the model. For example, a target output for a biased subgroup may be a value between the actual output and the median, average, or least-biased output, or equal to the median, average, or least-biased output. Based on the target output, the model may be adjusted by increasing and/or decreasing the weights (e.g., impact) of one or more parameters considered by the model (e.g., one or more parameters that account for a predetermined percentage of influence).

In non-limiting embodiments, the model may be automatically adjusted in response to determining a bias (e.g., an associated differential or other metric associated with the bias) that satisfies a threshold in step 312. In non-limiting embodiments or aspects, a model adjustment system may adjust the model by removing and/or reducing the weight of one or more variables that correspond to account holder parameters determined to be causing the bias. The adjusted model may then be executed based on the same input data (e.g., the same account holder parameters for a particular subgroup and/or account holder in the subgroup). The model may be adjusted by removing, adding, rebalancing, and/or combining input variables. In some examples, a target bias is identified such that, even if the bias cannot be entirely eliminated, the model is approved if the bias is equal to or less than a target threshold. In some examples, the model may be adjusted and re-executed such that a new output can be analyzed and further incremental adjustments can be made until the output is determined to be acceptable. For example, one or more data correction techniques (e.g., re-sampling, removal, data modification, and/or the like) may be applied incrementally until a bias of the model (e.g., a bias score) satisfies a threshold.

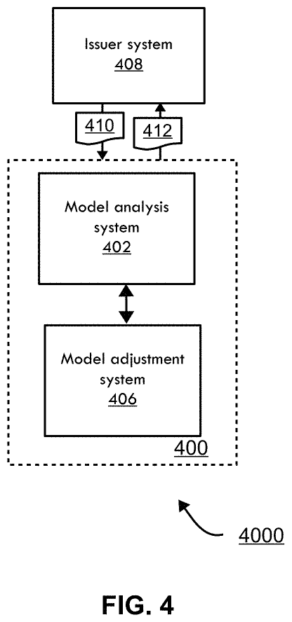

Referring now to FIG. 4, a system 4000 for adjusting a model is shown according to non-limiting embodiments or aspects. The system 4000 includes a model processing system 400, which may be made available to one or more client devices (e.g., an issuer system 408) through a Software-as-a-Service (SaaS) platform. It will be appreciated that the model processing system 400 may additionally or alternatively be executed locally to one or more computing devices. The model processing system 400 may include one or more software applications executing on one or more computing devices. The model processing system 400 may include a model analysis system 402 and a model adjustment system 406. Each of the model analysis system 402 and model adjustment system 406 may be the same or separate software applications executed by the same or separate computing devices.

With continued reference to FIG. 4, in operation, a client device, such as an issuer system 408, another issuer system, and/or any other entity, communicates a model 410 to the model processing system 400. In addition to the model 410, in some examples, data associated with the model (e.g., transaction data, account holder data, and/or the like) may be communicated or identified. The model analysis system 402 executes the model 410 for each subgroup of a plurality of subgroups. In some examples, the model analysis system 402 may include tools (e.g., accessible via one or more graphical user interfaces (GUIs)) that are provided to users (e.g., such as users of the issuer system 108, merchants, and/or the like) to screen for certain parameters (e.g., sensitive attributes) and detecting a level of bias by a subgroup. The model analysis system 402 may also provide a service during model creation by including bias determinations during the creation process. A model adjustment system 406 adjusts the models based on the bias (e.g., based on one or more differentials) determined by the model analysis system 402. The model processing system 400 may then output an adjusted model 412 (e.g., non-biased or less-biased model) and communicate it to the client (e.g., issuer system 408). In some examples, the model processing system 400 may also output analytical data (e.g., statistics or other insights about the bias, model, adjustments, and/or the like) that are communicated with the adjusted model. In examples in which the model is not adjusted, the model processing system 400 may still communicate analytical data to the client.

In non-limiting embodiments, the model processing system 400 may validate an adjusted model by executing it with transaction data and/or account parameters used to execute the original model. In some examples, an out-of-time validation may be performed to ensure that the adjustments to the model are effective and are not overfitting for a time period. For example, a sliding window approach with twelve sliding windows (e.g., one for each month) may be taken to account for seasonability. It will be appreciated that various methods of validating the adjusted model may be used in non-limiting embodiments.

In non-limiting embodiments, the model processing system 400 may be used to build models to reduce a bias. For example, additionally or alternatively to executing an existing model for each subgroup of a plurality of subgroups, several variations of a model may be generated, where each variation is based on different parameters and/or parameter weights. For example, models can be generated with and without sensitive parameters, such as gender, age, ethnicity, and/or the like. In this manner, each model of the multiple generated models may be executed for the same set of input data (e.g., account holder parameters, transaction data, and/or the like). A correlation matrix may then be used to identify signals correlated with sensitive variables. The model may then be adjusted, or an appropriate model identified from a plurality of models, by removing variables that cause the bias, including removing variables or reducing weights of such variables having a low impact and/or of variables that can be proxied with other (e.g., less sensitive) variables. For example, if a total amount of spend for an account is correlated with age, and age is determined to be a sensitive variable, then age can be removed from the model or a weight associated with age can be reduced.

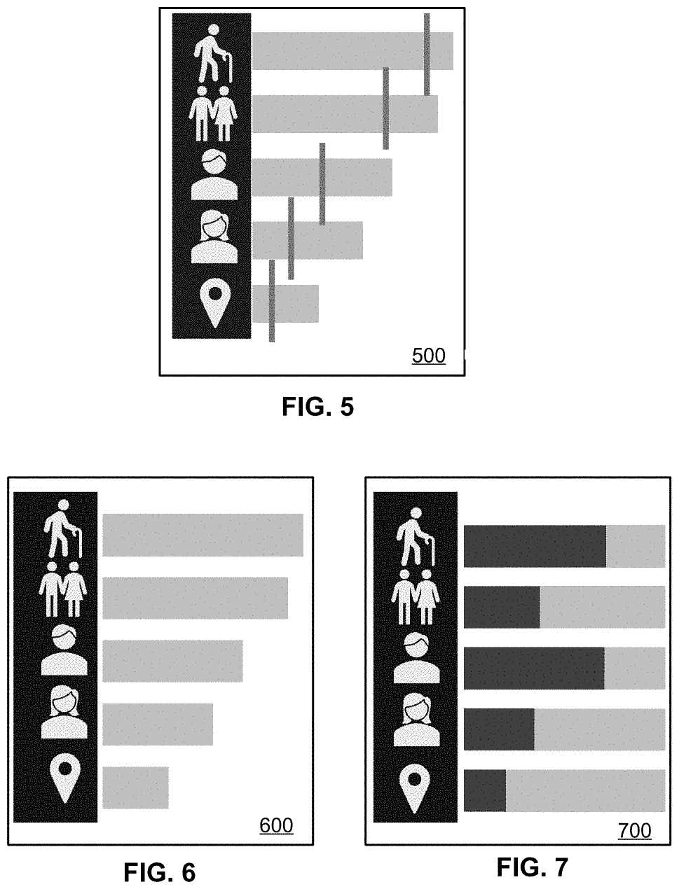

Referring now to FIGS. 5, 6, and 7, shown are GUIs 500, 600, 700 or components thereof according to non-limiting embodiments. The GUI 500 shown in FIG. 5 may be displayed to a user to show the likelihood of each subgroup receiving an offer based on historical transaction data. In some examples, the GUI 500 may be interactive such that a user can adjust one or more thresholds for different categories of variables (e.g., relating to age, marital status, gender, location, etc.) through selectable options, such as a slide bar. The GUI 600 shown in FIG. 6 is the GUI 500 from FIG. 5 without selectable options to adjust a threshold. The GUI 600 shows, through the use of a bar graph, potential segments of the population (e.g., subgroups) that are impacted by an analyzed model or that are at risk of being biased by models in general. For example, the GUI 600 may show a user that a particular model that was processed and analyzed is most biased against age (e.g., the top group in GUI 600) and least biased against location (e.g., the lower group in GUI 600). The GUI 700 shown in FIG. 7 shows a model performance metric that is combined from multiple executions of the model (e.g., across various categories and segments).

In non-limiting embodiments, models may be assigned a bias score using one or more algorithms. For example, in non-limiting embodiments, parity among demographic groups for having the same probability of receiving an offer (Pr) is represented, according to an ideal situation, as Pr(ŷ=1,p=1)−Pr(ŷ=1,p=0)=0, where ŷ∈{0,1} represents the outcome of not receiving (0) or receiving (1) an offer. Further, p∈{0,1} may be defined as the population (p) where 0 represents an underprivileged group (based on gender, ethnicity, or age, as an example) and 1 represents a privileged group. The probability of receiving an offer (Pr) may be independent of the population group such that both true positive and false positive rates are the same for all groups, as represented by Pr(ŷ|y,p)=Pr(ŷ|y). Similarly, an equation that focuses only on the privileged outcome (receiving an offer) may be represented in an ideal scenario as Pr(ŷ=1,y=1,p=1)−Pr(ŷ=1,y=1,p=0)=0. It will be appreciated that various equations and metrics may be used to represent the bias of a model and/or to score a model.

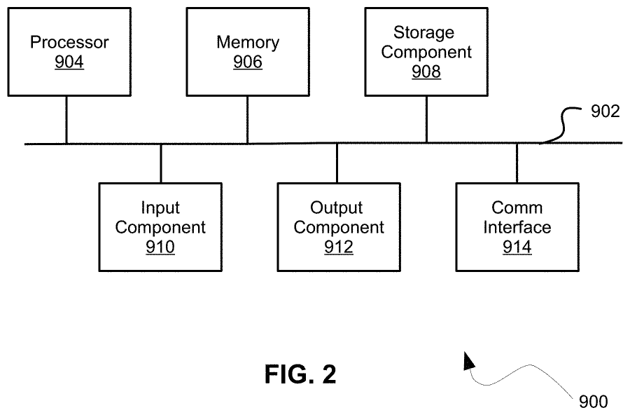

Referring now to FIG. 2, shown is a diagram of example components of a device 900 according to non-limiting embodiments. Device 900 may correspond to the model adjustment system 102 in FIG. 1, as an example. In some non-limiting embodiments, such systems or devices may include at least one device 900 and/or at least one component of device 900. The number and arrangement of components shown are provided as an example. In some non-limiting embodiments, device 900 may include additional components, fewer components, different components, or differently arranged components than those shown in FIG. 1. Additionally, or alternatively, a set of components (e.g., one or more components) of device 900 may perform one or more functions described as being performed by another set of components of device 900.

As shown in FIG. 2, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 2, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method comprising:
training or receiving, with at least one processor, a model based on transaction data for a plurality of account holders, the model configured to classify each individual of the plurality of account holders;
segmenting, with at least one processor, each individual of at least a portion of account holders of the plurality of account holders into at least one subgroup of a plurality of subgroups;
separately executing, with at least one processor, the model for each subgroup of the plurality of subgroups by inputting, into the model, a portion of the transaction data associated with individuals in each subgroup;
comparing, with at least one processor, a plurality of outputs of the model resulting from the separate execution of the model for each subgroup of the plurality of subgroups; and
adjusting, with at least one processor, the model based on at least one differential between the plurality of outputs.

2. The computer-implemented method of claim 1, wherein segmenting each individual of the plurality of account holders into the at least one subgroup of the plurality of subgroups comprises:
determining, with at least one processor, that at least one account holder parameter for each individual matches a predetermined account holder parameter comprising at least one of the following: a gender, an age, an age range, a location, a region, a credit limit, an account balance, or any combination thereof; and
in response to determining that the at least one account holder parameter matches the predetermined account holder parameter, associating an identifier corresponding to each individual to a subgroup corresponding to the predetermined account holder parameter.

3. The computer-implemented method of claim 1, wherein comparing the plurality of outputs of the model from the separate execution of the model for each subgroup of the plurality of subgroups comprises:
determining, for each subgroup of the plurality of subgroups, a metric based on at least one output associated with the subgroup; and
determining the at least one differential based on a difference between the metric for a first subgroup of the plurality of subgroups and at least one of the following: a metric for a second subgroup of the plurality of subgroups, an average metric for the plurality of subgroups, a median metric for the plurality of subgroups, or any combination thereof.

4. The computer-implemented method of claim 1, wherein comparing the plurality of outputs of the model from the separate execution of the model for each subgroup of the plurality of subgroups comprises:
determining, with at least one processor, that a predetermined number of account holder parameters for each individual is a basis for at least a predetermined percentage of an output of the plurality of outputs.

5. The computer-implemented method of claim 1, further comprising:
generating, with at least one processor, the model.

6. The computer-implemented method of claim 1, further comprising:
receiving, from a remote computing device, the model; and
communicating the model to the remote computing device after it is adjusted.

7. A system comprising at least one processor configured to:
train a model based on transaction data for a plurality of account holders, the model configured to classify each individual of the plurality of account holders;
segment each individual of at least a portion of account holders of the plurality of account holders into at least one subgroup of a plurality of subgroups;
separately execute the model for each subgroup of the plurality of subgroups by inputting, into the model, a portion of the transaction data associated with individuals in each subgroup;
compare a plurality of outputs of the model resulting from the separate execution of the model for each subgroup of the plurality of subgroups; and
adjust the model based on at least one differential between the plurality of outputs.

8. The system of claim 7, wherein segmenting each individual of the plurality of account holders into the at least one subgroup of the plurality of subgroups comprises:
determining that at least one account holder parameter for each matches a predetermined account holder parameter comprising at least one of the following: a gender, an age, an age range, a location, a region, a credit limit, an account balance, or any combination thereof; and
in response to determining that the at least one account holder parameter matches the predetermined account holder parameter, associating an identifier corresponding to each individual to a subgroup corresponding to the predetermined account holder parameter.

9. The system of claim 7, wherein comparing the plurality of outputs of the model from the separate execution of the model for each subgroup of the plurality of subgroups comprises:
determining, for each subgroup of the plurality of subgroups, a metric based on at least one output associated with the subgroup; and
determining the at least one differential based on a difference between the metric for a first subgroup of the plurality of subgroups and at least one of the following: a metric for a second subgroup of the plurality of subgroups, an average metric for the plurality of subgroups, a median metric for the plurality of subgroups, or any combination thereof.

10. The system of claim 7, wherein comparing the plurality of outputs of the model from the separate execution of the model for each subgroup of the plurality of subgroups comprises:
determining that a predetermined number of account holder parameters for each individual is a basis for at least a predetermined percentage of an output of the plurality of outputs.

11. The system of claim 7, wherein the at least one processor is further configured to generate the model.

12. The system of claim 7, wherein the at least one processor is further configured to:
receive, from a remote computing device, the model; and
communicate the model to the remote computing device after it is adjusted.

13. A computer program product comprising at least one non-transitory medium including program instructions which, when executed by at least one processor, cause the at least one processor to:
train a model based on transaction data for a plurality of account holders, the model configured to classify each individual of the plurality of account holders;
segment each individual of at least a portion of account holders of the plurality of account holders into at least one subgroup of a plurality of subgroups;
separately execute the model for each subgroup of the plurality of subgroups by inputting, into the model, a portion of the transaction data associated with individuals in each subgroup;
compare a plurality of outputs of the model resulting from the separate execution of the model for each subgroup of the plurality of subgroups; and
adjust the model based on at least one differential between the plurality of outputs.

14. The computer program product of claim 13, wherein segmenting each individual of the plurality of account holders into the at least one subgroup of the plurality of subgroups comprises:
determining that at least one account holder parameter for each matches a predetermined account holder parameter comprising at least one of the following: a gender, an age, an age range, a location, a region, a credit limit, an account balance, or any combination thereof; and
in response to determining that the at least one account holder parameter matches the predetermined account holder parameter, associating an identifier corresponding to each individual to a subgroup corresponding to the predetermined account holder parameter.

15. The computer program product of claim 13, wherein comparing the plurality of outputs of the model from the separate execution of the model for each subgroup of the plurality of subgroups comprises:
determining, for each subgroup of the plurality of subgroups, a metric based on at least one output associated with the subgroup; and
determining the at least one differential based on a difference between the metric for a first subgroup of the plurality of subgroups and at least one of the following: a metric for a second subgroup of the plurality of subgroups, an average metric for the plurality of subgroups, a median metric for the plurality of subgroups, or any combination thereof.

16. The computer program product of claim 13, wherein comparing the plurality of outputs of the model from the separate execution of the model for each subgroup of the plurality of subgroups comprises:
determining that a predetermined number of account holder parameters for each individual is a basis for at least a predetermined percentage of an output of the plurality of outputs.

17. The computer program product of claim 13, wherein the instructions further cause the at least one processor to generate the model.

18. The computer program product of claim 13, wherein the instructions further cause the at least one processor to:
receive, from a remote computing device, the model; and
communicate the model to the remote computing device after it is adjusted.
